(19) United States
(12) Patent Application Publication
(10) Pub. No.: US 2015/0204403 A1
(43) Pub. Date: Jul. 23, 2015

(54) Graphite Coated Fibres

(71) Applicant: Rockwool International A/S, Hedehusene (DK)

(72) Inventors: Luc Johannes Petrus Smeets, Herten (NL); Siske Bos, Roermond (NL)

(73) Assignee: Rockwool International A/S, Hedehusene (DK)

(21) Appl. No.: 14/421,684

(22) PCT Filed: Aug. 13, 2013
(86) PCT No.: PCT/EP2013/066932

§ 371 Date: Feb. 13, 2015

(30) Foreign Application Priority Data
Aug. 13, 2012 (EP) 12180219.3

(51) Int. Cl. F16D 69/02; C03C 25/28; C03C 25/44

(52) U.S. Cl. CPC F16D 69/028; C03C 25/44; C03C 25/28

(57) ABSTRACT

The invention relates to coated fibres wherein said fibres are mineral fibres and said coating comprises a rubber and graphite. The invention further relates to a brake pad and a clutch facing comprising the coated fibres.

The invention relates to coated fibres wherein said fibres are mineral fibres and said coating comprises a rubber and graphite. The invention further relates to a brake pad and a clutch facing comprising the coated fibres. Such coated mineral fibres and products thereof impart increased thermal conductivity and improved friction/wear properties.

In the past, copper was often used as an additive in friction materials such as brake pads and clutch facings, in order to provide good thermal conductivity, cracking resistance and desirable friction/wear properties. In particular, providing improved thermal conductivity in friction materials is important in order to conduct the heat away from the friction surface during braking. When the heat is accumulated at the friction surface, this can cause fading problems. In addition, accumulation of heat can cause excessive degradation of components on the friction surface, increasing the wear of a brake pad.

However, in view of stricter regulations on the use of copper, it would be beneficial to replace the use of copper with other materials which are “greener” or more environmentally friendly, whilst at the same time, maintaining the unique combination of properties required in such friction materials.

As disclosed in JP 5247446, graphite offers one such alternative. JP 5247446 discloses the use of friction materials comprising a filler such as graphite, for use in brake pads, brake linings and clutch facings. Such friction materials impart improved shock resistance and reduced squeal. However, simply incorporating graphite in friction materials as a filler is often not sufficient to provide good thermal conductivity.

WO 2007/136559 discloses a graphite coated fibre comprising an electrically insulating fibre having an outer surface; and exfoliated and pulverised graphite platelets coated on the outer surface of the electrically insulating fibre with a cationic or anionic polymer or mixtures thereof. However the fibres would not be considered suitable for high temperatures uses, due to their lack of thermal stability.

Stone fibres coated with rubber are known for their use in friction material formulations. The rubber functions to improve acoustical properties such as to diminish the squeal associated with car brakes.

However it would be desirable to provide improved embodiments which overcome some of the deficiencies noted above. Accordingly, the invention provides coated mineral fibres which provide increased thermal conductivity for use in a variety of applications, and in particular for use in friction materials such as brake pads and clutch facings. The present invention solves these problems.

### SUMMARY OF INVENTION

In accordance with a first aspect of the invention, there is provided a coated fibre wherein said fibre is a mineral fibre and said coating comprises a rubber and graphite.

In accordance with a second aspect of the invention, there is provided a friction material comprising a coated fibre according to the first aspect of the invention.

### DETAILED DESCRIPTION OF THE INVENTION

Mineral Fibres

Mineral fibres include both crystalline materials as well amorphous materials formed by a melting process, such as man-made vitreous fibres. Examples of fibres are carbide fibres, such as silicon carbide fibres, boron carbide fibres, niobium carbide fibres; nitride fibres, such as silicon nitride fibres; boron containing fibres, such as boron fibres, boride fibres; silicon-containing fibres, such as silicon fibres, alumina-boron-silica fibres, E-glass (non-alkaline alumoborosilicate) fibres, mineral-glass fibres, non-alkaline magnesia alumosilicate fibres, quartz fibres, silicic acid fibres, silica fibres, high-silica fibres, alumina high-silica fibres, alumosilicate fibres, aluminium silicate fibres, magnesia alumosilicate fibres, soda borosilicate fibres, soda silicate fibres, polycarbosilane fibres, polytitanocarbosilane fibres, polysilazane fibres, hydridopolysilazane fibres, tobermorite fibres, samarium silicate fibres, wollastonite fibres, potassium aluminium silicate fibres, ceramic fibres, slag wool fibres, charcoal fibres; stone fibres, basalt fibres, continuous basalt fibres; processed mineral fibres from mineral wool; attapulgite fibres; etc.; modified by any chemical or physical processes; and any mixture thereof.

Preferred examples of such mineral fibres are E-glass fibres, mineral-glass fibres, wollastonite fibres, ceramic fibres, slag wool fibres, stone wool fibres; basalt fibres, continuous basalt fibres, and processed mineral fibres from mineral wool. More preferred examples of such mineral fibres are wollastonite fibres, ceramic fibres, slag wool fibres, stone wool fibres; basalt fibres, continuous basalt fibres, and processed mineral fibres from mineral wool. Stone fibres are particularly preferred due to their high temperature resistance, which make them suitable for applications such as brake pads and clutch facings—.

The mineral fibre mixtures obtained mainly consist of loose mineral fibres. A mineral fibre mixture such as a stone fibre mixture typically includes a certain content of non-fibrous material such as shots, the content of which may vary depending on the manufacture process employed. Such mineral fibre mixtures are commercially available.

The mineral fibres have been processed to lower the shot content, especially when the fibres are used for brake pad formulations. Preferably there is less than 20% by weight based on the total fibre weight, of shot present with the mineral fibres in the composition. Most preferably there is less than 5% by weight of shot, most preferably less than 1% by weight of shot present in the resulting mineral fibres, and even more preferably less than 0.2% by weight of shot present in the mineral fibres. Shot is solid charge with a particle diameter of greater than 125 μm. The reduction in the amount of shot present in the resulting mineral fibres means that a greater percentage of the mineral fibre mixture consists of fibres. Additionally the resulting product has less shot present which therefore results in a high quality product.

Suitable stone fibres have content by weight of oxides as follows:
SiO₂ 25 to 50%, preferably 38 to 48%
Al₂O₃ 4 to 30%, preferably 15 to 28%
TiO₂ up to 6%
Fe₂O₃ 2 to 15%
CaO 5 to 30%, preferably 5 to 18%
MgO up to 20% preferably 1 to 8%
Na₂O up to 15%
K₂O up to 15%

A preferred fibre useful in the invention, has oxide contents by weight in the following ranges:
SiO₂ 37 to 42%
Al₂O₃ 18 to 23%
CaO+MgO 34 to 39%
Fe₂O₃ up to 1%
Na₂O+K₂O up to 3%

Usually, the fibres used in the invention have an average diameter of from 2 to 50 μm, preferably from 2 to 25 μm and even more preferably from 2 to 10 μm. In another preferred embodiment, the fibres have an average diameter from 5 to 6 μm. According to the present invention, the average fibre diameter is determined for a representative sample by measuring the diameter of at least 500 individual fibres by means of scanning electron microscope or optical microscope.

The fibres used in the present invention may have an average length from 100 to 750 μm, preferably from 100 to 500 μm, more preferably from 100 to 300 μm and even more preferably from 100 to 200 μm. The average fibre length is determined for a representative sample by measuring the length of at least 500 individual fibres by means of scanning electron microscope or optical microscope.

The fibres may have an aspect ratio ranging from 10:1 to 150:1, preferably from 20:1 to 75:1 and even more preferably from 20:1 to 50:1. Aspect ratio as used herein refers to the ratio of the fibre length to diameter.

Examples of commercially available mineral fibres used in the invention are

CoatForce® CF10, ex. Lapinus Fibres (The Netherlands), CoatForce® CF30, ex. Lapinus Fibres BV (The Netherlands), CoatForce® CF50, ex. Lapinus Fibres BV (The Netherlands), Rockforce® MS603-Roxul ® 1000, ex. Lapinus Fibres BV (The Netherlands), Rockforce® MS610-Roxul® 1000, ex. Lapinus Fibres BV (The Netherlands) and RockBrake® RB215-Roxul® 1000, ex. Lapinus Fibres BV (The Netherlands).

Other fibres may be Vitrostrand 1304 and 1320 K, PMF® 204 (Isolatek), Perlwolle (Isola Mineralwolle), Thermafiber FRF (Thermafiber).

The fibres can be produced by standard methods such as with a cascade spinner or a spinning cup. However, in order to achieve the required length distribution of the fibres, it will usually be necessary for the fibres to be processed further after the standard production.

In a preferred embodiment, the fibres are biodegradable under physiological conditions, especially in the respiratory organs (the lungs) of mammals, especially humans. The degree of biodegradability should preferably be at least 20 nm/day, such as at least 30 nm/day, in particular at least 50 nm/day when tested as described in WO 96/14454. Examples of suitable biodegradable fibres are the ones described in WO 96/14454 and WO 96/14274. A specific example thereof is the commercially available RockBrake® RB215-Roxul® 1000, ex. Lapinus Fibres BV (The Netherlands).

Graphite

Graphite is a form of highly crystalline carbon. Graphite useful herein can be substantially as described in U.S. Pat. No. 5,139,642. Graphite used in the present invention may be either synthetic or naturally occurring. Synthetic graphite is particularly preferred and refers to graphite made by high pressure and temperature processing of carbon. Special grade graphite such as exfoliated, expanded or intercalated graphite are not preferred for the purposes of graphite used in the present invention. The graphite can either be supplied in the form of a powder or in the form of a dispersion. Accordingly suitable commercial graphites and graphite dispersions contemplated to be useful herein include ULTRAFINE GRAPHITE, sold by Showa Denko K.K., Tokyo, Japan; AQUADAGE E; MICRO 440, sold by Asbury Graphite Mills Inc., Asbury, N.J.; GRAPHITE 850, also sold by Asbury; GRAFO 1204B, sold by Metal Lubricants Company, Harvey, Ill.; GRAPHOKOTE 90, sold by Dixon Products, Lakehurst, N.J.; NIPPON AUP (0.7 μm), sold by Nippon Graphite Industries, Ltd., Ishiyama, Japan; TIMREX® E-LB 2053, sold by TIMCAL Graphite & Carbon, Ohio, USA; and others having similar electrical and dispersion characteristics.

The graphite preferably has a mean particle size within the range of between 0.01 to 15 μm, more preferably between 0.1 to 5 μm, and even more preferably between 0.15 to 3 μm. From the perspective of performance and ease of dispersion particles from the smaller end of the size range are preferred. Graphite particles of suitable size can be prepared by wet grinding or milling of raw graphite, having a particle size greater than 50 μm, to form a slurry of smaller particles. Graphite particles of suitable size may also be formed by graphitising already-small carbon-containing particles.

The graphite is preferably distributed homogeneously within the rubber coating in order to obtain a consistent dispersion of graphite particles within the coating. Such homogeneous distribution contributes to the increased thermal conductivity of the resulting coating.

Graphite is preferably present in an amount between 0.1 and 10 wt %, preferably between 0.2 and 5 wt % and even more preferably between 0.5 an 3 wt %, based on the total weight of the coated fibres.

The ratio of graphite:rubber is preferably between 1:1 and 1:15 and more preferably between 1:2 and 1:8.

Rubber

Rubber used in the present invention may be derived from a latex composition. The term “latex” therefore refers to a composition which contains a dispersion or emulsion of polymer particles formed in the presence of water.

Any rubber known to those skilled in the art may be used to form the coating used on the fibre. The rubber may be a natural or synthetic rubber. In a preferred aspect of the invention, the rubber is cross-linked and is selected from the group consisting of acrylic, NBR (acrylonitrile-butadiene rubber), PUC (polyurethane carbonate), SBR (styrene-butadiene rubber) and epoxy rubbers. Accordingly a suitable commercial rubber contemplated to be useful herein includes Vinacryl 4025, sold by Celanese Corporation, Texas, USA.

The rubber coating preferably has a thickness of between 0.1 and 20 μm, and more preferably between 0.1 and 10 μm.

Other Components

Other components may further be present in the coating composition used in the present invention. In particular, when graphite is provided in the form of a dispersion, one or more stabilisers and/or dispersing agents may be used.

Coated fibres

The coated fibres according to the present invention are preferably in the form of individually coated, loose fibres i.e. not in an aggregate mass, but coated in a manner such that they are not adhered to one another. Such coated fibres can be incorporated to compositions for use in frictions materials, such as brake pad material matrix.

Such brake pad matrix compositions may comprise other ingredients besides the coated fibres. Such ingredients may include one or more barites, resin, friction dust, other fibres such as aramid, stone fibres and/or metal fibres, iron oxide, alumina, zircon dioxide and molybdenum disulfide.

Coating Method

The fibre may be coated with a coating composition comprising rubber and graphite by any method known to those skilled in the art. Preferably the coating composition is applied to the fibre in the form of a latex.

For example, the coated fibres may be formed by:
a) Mixing the graphite into a dispersion of rubber in a liquid vehicle, which may be a solution, but is preferably a latex, i.e. wherein water is the continuous phase, to form a suspension;
b) using said suspension to coat the mineral fibres, while suspended in a fluid e.g. a gas; and
c) curing the coating in a two-phase system, for example suspended in a gas, to form a solid coating of rubber and graphite.

The liquid vehicle is preferably water, an aqueous liquid or an organic solvent, e.g. an alcohol. Most preferably, the liquid vehicle is water.

For step a), the graphite particles may be ultrasonically mixed with the dispersion of rubber in a liquid vehicle, to provide the resultant suspension.

The coating step b) may be carried out by spraying or dipping the mineral fibres with the graphite suspension. When the mineral fibres are coated using the dipping method, the fibres may optionally be dipped into water to remove any excess graphite suspension. The coating time is preferably between 2 and 100 seconds, more preferably between 5 and 50 seconds, and even more preferably between 5 and 20 seconds.

The curing step may involve removal of the liquid, e.g. by drying of the rubber.

### INDUSTRIAL APPLICATION

The coated fibres according to the present invention are particularly useful for applications which require increased thermal conductivity. This is attributed to the incorporation of the graphite within the rubber coating.

In a preferred embodiment, the coated fibres may be incorporated into various friction materials such as brake pads and clutch facings.

An advantage of using a coated mineral fibre of the invention is that the coating ensures that graphite is located in close proximity to the mineral fibre and thus thermal conductivity is more efficient. This means that the coated fibres have particular utility in friction materials such as brake pads and clutch facings. When used in a friction material, the fibres of the present invention are more efficient at thermal conduction than using uncoated fibres and graphite in a friction material. This is because the coated fibres form a network within a friction material which allows efficient thermal conductivity, whereas uncoated fibres and graphite do not form a network within the friction material. A friction material according to the present invention therefore requires less other conductive material, such as copper, to achieve thermal conduction through it, than if uncoated fibres and graphite were used.

### EXAMPLES OF THE PRESENT INVENTION

The following examples of the present invention are merely exemplary and should not be viewed as limiting the scope of the invention.

### Example 1

The graphite used for coating is in the form of a dispersion of high purity synthetic graphite with graphite content between 25 and 29%. The particle size is between 0.2 and 2.1 micron.

The latex is an SBR rubber type with 50% solid rubber and particle size between 0.15 and 0.25 micron.

The fibre is a stone fibre with length between 125 and 175 micron and shot content (>125 micron) between 0 and 0.5%.

The suspension of graphite is further dispersed with water, using the ratio 1:1 for water and graphite dispersion. The latex and graphite are then combined, and the resultant mixture is dispersed over the fibre surface. The coated fibres are subsequently dried to a moisture content of less than 1%.

Each coated fibre comprises approximately 4 wt % rubber and 1 wt % graphite based on the total weights of the fibre.

To measure thermal conductivity the coated fibres are mixed with a resin commonly used in brake pads and then pressed at 165 ° C. and 10 MPa for 7 minutes with 4 degassing cycles. Then the brake pads are pressed with equal thickness and porosity and checked on flatness.

For the measurement a pad containing the coated fibre and resin is placed on a heating plate. The plate has constant temperature of 500° C. The pad placed on the heating plate is insulated during the measurement. Using a thermocouple and thermo-logger the temperature on the top side of the brake pad is measured and logged.

From the data the slope is determined in the heating curve between 100-300° C. The thermal conductivity is then defined as the rate of temperature increase in this temperature range. Results from the thermal conductivity measurements are shown in the table below.

### Example 2

The method of Example 1 was used to make coated fibres and form a brake pad using the fibres. In Example 2, the latex is an acrylic rubber type with 50% solid rubber and particle size between 0.20 and 0.25 micron. The graphite is the type from Example 1. The thermal conductivity of the brake pad was measured in accordance with the method Example 1. Results from the thermal conductivity measurements are shown in the table below.

COMPARATIVE DATA

The method of Example 1 was used to form a brake pad using uncoated fibres. The thermal conductivity of the brake pad was measured in accordance with the method Example 1. Results from the thermal conductivity measurements are shown in the table below.

Results from the thermal conductivity measurements are shown in the table below.

| | | Thermal | Standard |
|---|---|---|---|
| | | conductivity (° C./s) | deviation |
| Comparison | Uncoated fibres | 0.822 | 0.041 |
| Example 1 | SBR latex + graphite | 1.080 | 0.016 |
| | dispersion | | |
| Example 2 | Acryl latex + graphite | 1.075 | 0.015 |
| | dispersion | | |

An increase of approximately 30% in thermal conductivity of the brake pads containing the coated fibres compared to the brake pads containing the uncoated fibres can be seen from the table.

1. A coated fibre wherein said fibre is a mineral fibre and said coating comprises a rubber and graphite.

2. The coated fibre according to claim 1, wherein said rubber is selected from the group consisting of acrylic, NBR, PUC, SBR and epoxy rubbers.

3. The coated fibre according to claim 1 or claim 2, wherein said coating has a thickness of between 0.1 and 20 μm.

4. The coated fibre according to claim 1 any preceding claim, wherein said fibre is selected from the group consisting of wollastonite fibres, ceramic fibres, slag wool fibres, stone wool fibres, basalt fibres, continuous basalt fibres, and processed mineral fibres from mineral wool or any combination thereof.

5. The coated fibre according to claim 4, wherein said fibre is a stone fibre having oxide contents by weight in the following ranges:
SiO₂ 25 to 50%, preferably 38 to 48;
Al₂O₃ 4 to 30%, preferably 15 to 28%;
TiO₂ up to 6%;
Fe₂O₃ 2 to 15%;
CaO 5 to 30%, preferably 5 to 18%;
MgO up to 20% preferably 1 to 8%;
Na₂O up to 15%; and
K₂O up to 15%;

6. The coated fibre according to claim 4, wherein said fibre is a stone fibre having oxide contents by weight in the following ranges:
SiO₂ 37 to 42%;
Al₂O₃ 18 to 23%;
CaO+MgO 34 to 39%;
Fe₂O₃ up to 1%; and
Na₂O+K₂O up to 3%.

7. The coated fibre according to claim 1, wherein said fibre has an average length of from 100 to 750 μm.

8. The coated fibre according to claim 1, wherein said fibre have an aspect ratio ranging from 20:1 to 150:1.

9. The coated fibre according to claim 1, wherein said graphite has a mean particle size of between 0.01 and 15 μm.

10. The coated fibre according to claim 1, wherein the fibre is in the form of an individually coated, loose fibre.

11. A friction material comprising the coated fibre according to claim 1.

12. The friction material according to claim 11, wherein said material is a brake pad.

13. The friction material according to claim 11, wherein said material is a clutch facing.
